(19) United States
(12) Patent Application Publication
(10) Pub. No.: US 2024/0348413 A1
(43) Pub. Date: Oct. 17, 2024

(54) RADIO NODE AND RADIO COMMUNICATION METHOD

(71) Applicant: NTT DOCOMO, INC., Tokyo (JP)

(72) Inventors: Daisuke Kurita, Tokyo (JP); Hiroki Harada, Tokyo (JP); Weiqi Sun, Beijing (CN); Jing Wang, Beijing (CN); Lan Chen, Beijing (CN)

(73) Assignee: NTT DOCOMO, INC., Tokyo (JP)

(21) Appl. No.: 18/682,334

(22) PCT Filed: Aug. 17, 2021
(86) PCT No.: PCT/JP2021/030087

§ 371 Date: Feb. 8, 2024

(51) Int. Cl. H04L 5/14; H04L 27/26

(52) U.S. Cl. CPC H04L 5/14; H04L 27/2666

(57) ABSTRACT

A radio node that has: a communication unit that performs a simultaneous communication operation whereby a first communication with a child node or a terminal and a second communication with a parent node are conducted simultaneously and an independent communication operation whereby either the first communication or the second communication is performed; and a control unit that, on the basis of either a report to the parent node or a notification from the parent node, or both, makes a determination to switch between the simultaneous communication operation and the independent communication operation.

### TECHNICAL FIELD

The present disclosure relates to a radio node and a radio communication method.

### BACKGROUND ART

Long Term Evolution (LTE) has been specified for achieving a higher data rate, lower latency, and the like in a Universal Mobile Telecommunication System (UMTS) network. Future systems of LTE have also been studied for achieving a broader bandwidth and a higher speed based on LTE. Examples of the future systems of LTE include systems called LTE-Advanced (LTE-A), Future Radio Access (FRA), 5th generation mobile communication system (5G), 5G plus (5G+), Radio Access Technology (New-RAT), New Radio (NR), and the like.

Further, in NR, a technique of Integrated Access and Backhaul (IAB) that unifies an access link and a backhaul link has been studied. In LAB, a radio node such as an IAB node forms a radio access link with a user terminal (User Equipment (UE): may be simply referred to as terminal) and also forms a radio backhaul link with another IAB node and/or a radio base station.

An IAB node has a Mobile Termination (MT), which is a function for being connected to a parent node (another IAB node positioned one level upstream), and a Distributed Unit (DU), which is a function for being connected to with a child node (still another 1AB node positioned one level downstream) or a terminal. Note that, in the following, the MT of the IAB node may be denoted by an “IAB-MT,” and the DU of the IAB node may be denoted by an “IAB-DU.”

In Release 16 of 3GPP, radio access and radio backhaul are based on half-duplex communication and time division multiplexing (TDM). Meanwhile, in Release 17 and a later release, space division multiplexing (SDM) and frequency division multiplexing (FDM) have been studied.

In Non-Patent Literature (hereinafter referred to as “NPL”) 1, the following seven cases are specified with respect to transmission timing alignment (Timing Alignment (TA)) for an IAB node.
Case #1: Downlink (DL) transmission TA between an IAB and an IAB donor;
Case #2: DL and Uplink (UL) transmission TA within the IAB node;
Case #3: DL and UL reception TA within the IAB node;
Case #4: Transmission by Case #2 and reception by Case #3 within the IAB node;
Case #5: Application of Case #1 to an access link timing and application of Case #4 to a backhaul link timing within the IAB node in different time slots;
Case #6: DL transmission TA in Case #1 and UL transmission TA in Case #2 (i.e., combination of Case #1 DL transmission TA and Case #2 UL transmission TA); and
Case #7: DL transmission TA in Case #1 and UL reception TA in Case #3 (i.e., combination of Case #1 DL transmission TA and Case #3 UL reception TA).

Note that the term “alignment” may be replaced with another term such as adjustment, arraying, position adjustment, position alignment, or synchronization.

In NPL 2, as the Case #1 DL transmission TA, the adjustment of transmission timings for IAB-DUs which is based on the TDM and is for attaining synchronization among IAB nodes is specified.

### CITATION LIST

### Non-Patent Literature

NPL 1
3GPP TS 38.874 V16.0.0 (2018-12)
NPL 2
3GPP TS 38.213 V16.6.0 (2021-06)

### SUMMARY OF INVENTION

In Release 17 and a later release, a simultaneous transmission and a simultaneous reception by an IAB-MT and an IAB-DU (simultaneous operation) have been discussed. There is scope for further study on switching between a single operation by the IAB-MT and the IAB-DU and a simultaneous operation by the IAB-MT and the IAB-DU.

An aspect of the present disclosure is to provide a radio node and a radio communication method each capable of switching between a single operation by an IAB-MT and an IAB-DU and a simultaneous operation by the IAB-MT and the IAB-DU.

A radio node according to an aspect of the present disclosure includes: a communication section that performs a simultaneous communication operation and a single communication operation, the simultaneous communication operation being an operation in which first communication with a child node or a terminal and second communication with a parent node are simultaneously performed, the single communication operation being an operation in which either the first communication or the second communication is performed; and a control section that determines to switch between the simultaneous communication operation and the single communication operation, based on either one of or both of a report to the parent node and indication from the parent node.

A radio communication method according to an aspect of the present disclosure includes: performing a simultaneous communication operation and a single communication operation, the simultaneous communication operation being an operation in which first communication with a child node or a terminal and second communication with a parent node are simultaneously performed, the single communication operation being an operation in which either the first communication or the second communication is performed; and determining to switch between the simultaneous communication operation and the single communication operation, based on either one of or both of a report to the parent node and indication from the parent node.

### BRIEF DESCRIPTION OF DRAWINGS

FIG. 1 illustrates an exemplary configuration of a radio communication system according to an embodiment;

FIG. 2 illustrates an exemplary configuration of an IAB node;

FIG. 3 is a diagram for describing a scenario of operation switching between an MT and a DU;

FIG. 4 illustrates an exemplary Medium Access Control Control Element (MAC CE) used for guard symbol indication;

FIG. 5 illustrates an exemplary Case #1 timing mode;

FIG. 6 illustrates an exemplary Case #6 timing mode;

FIG. 7 illustrates an exemplary Case #7 timing mode;

FIG. 8 is a diagram for describing an example of Alt. 1 of Case 1;

FIG. 9 is a diagram for describing an example of Alt. 2 of Case 1;

FIG. 10 is a diagram for describing an example of a variation in Alt. 2 of Case 1;

FIG. 11 is a diagram for describing an example of Alt. 1 of Case 2;

FIG. 12 is a diagram for describing an example of a variation in Alt. 1 of Case 2;

FIG. 13 is a diagram for describing an example of Alt. 2 of Case 2;

FIG. 14 is a diagram for describing an example of Alt. 1 of Case 3;

FIG. 15 is a diagram for describing an example of Alt. 2 of Case 3;

FIG. 16 is a diagram for describing an example of a variation in Alt. 2 of Case 3;

FIG. 17 is a diagram for describing an example of Alt. 1 of Case 4;

FIG. 18 is a diagram for describing an example of a variation in Alt. 1 of Case 4;

FIG. 19 is a diagram for describing an example of Alt. 2 of Case 4;

FIG. 20 is a diagram for describing an example of Alt. 1+Opt. 1 in Proposal 2-2;

FIG. 21 is a diagram for describing an example of Alt. 1+Opt. 2 in Proposal 2-2;

FIG. 22 is a diagram for describing an example of Alt. 2+Opt. 1 in Proposal 2-2;

FIG. 23 is a diagram for describing an example of Alt. 2+Opt. 2 in Proposal 2-2;

FIG. 24 is a diagram for describing an exemplary modification in terms of support and application;

FIG. 25 illustrates an exemplary functional configuration of an IAB node or a terminal according to an embodiment of the present disclosure; and

FIG. 26 illustrates an exemplary hardware configuration of the IAB node or the terminal according to the embodiment of the present disclosure.

### DESCRIPTION OF EMBODIMENTS

Hereinafter, an embodiment according to an aspect of the present disclosure will be described in detail with reference to the accompanying drawings.

Hereinafter, an embodiment of the present disclosure will be described with reference to the drawings. Note that the embodiment to be described below is merely an example, and an embodiment to which the present disclosure is applied is not limited to the following embodiment.

Further, in the following embodiment of the present disclosure, terms used in 5G New Radio (NR) are used, such as a synchronization signal (SS), a primary SS (PSS), a secondary SS (SSS), a physical broadcast channel (PBCH), a physical random access channel (PRACH), a physical downlink control channel (PDCCH), a physical downlink shared channel (PDSCH), a physical uplink control channel (PUCCH), and a physical uplink shared channel (PUSCH). This is for convenience of description, and the same signals, functions, and the like may be called by other names.

Further, in the embodiment of the present disclosure, a duplex system may be a Time Division Duplex (TDD) system, a Frequency Division Duplex (FDD) system, or another system (e.g., Flexible Duplex or the like).

Further, in the embodiment of the present disclosure, the phrase “a radio parameter or the like is “configured,”” may refer to pre-configuration of a predetermined value or configuration of a radio parameter that is indicated from a base station or a terminal.

### Embodiment

### <System Configuration>

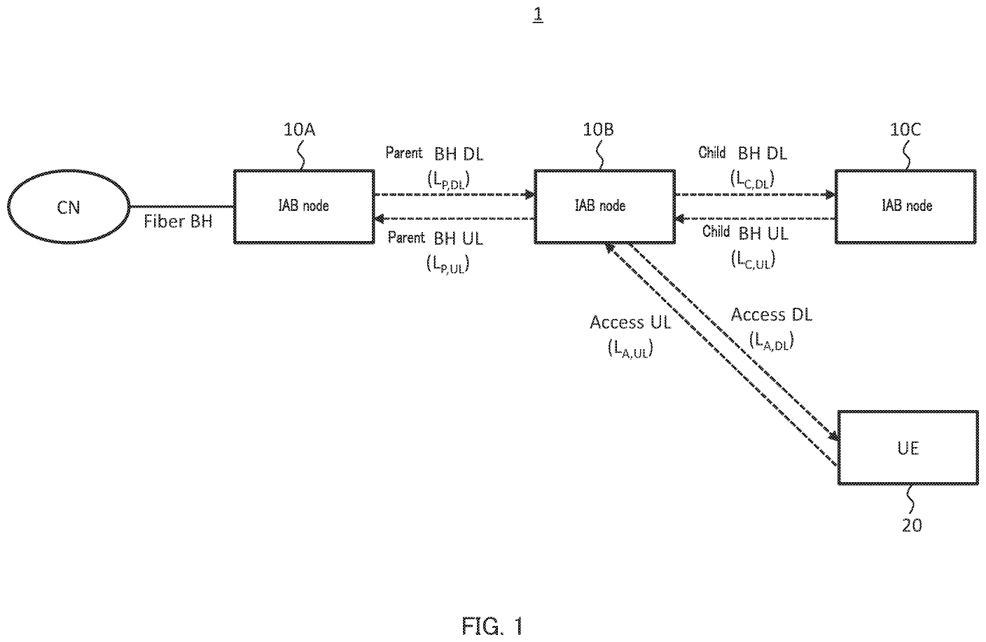

FIG. 1 illustrates an exemplary configuration of a radio communication system according to an embodiment. Radio communication system 1 includes a plurality of IAB nodes 10A to 10C as one example of radio nodes, and terminal 20. Hereinafter, to describe IAB nodes 10A to 10C without distinguishing them from one another, only the numeral common to the reference signs may be used as in “IAB node 10.”

IAB nodes 10A to 10C are connected to one another by radio communication. In FIG. 1, IAB node 10B is connected to IAB node 10A. IAB node 10C is connected to IAB node 10B.

In the following, IAB node 10A, which is positioned upstream (i.e., in UL direction) as viewed from IAB node 10B, is called parent IAB node 10A, and IAB node 10C, which is positioned downstream (i.e., in DL direction) as viewed from IAB node 10B, is called child IAB node 10C. That is, IAB node 10A is a parent node of IAB node 10B, and IAB node 10B is a child node of IAB node 10A. Note that the parent node may be called a higher (upper) node, and the child node may be may be called a lower node. Further, the parent node may be may be called an IAB donor.

Each of IAB nodes 10A to 10C forms a cell, which is an area in which the IAB node is available to perform radio communication. That is, each of IAB nodes 10 has a function as a base station. Terminal 20 in a cell can be connected by radio to IAB node 10 forming the cell.

Note that each of IAB nodes 10 having a function as a base station may be referred to as a gNodeB (gNB). Further, each of IAB nodes 10 may be regarded as an apparatus included in a network to which terminal 20 is connected.

Terminal 20 is a communication apparatus provided with a radio communication function, such as a smart phone, a mobile phone, a tablet, a wearable terminal, a Machine-to-Machine (M2M) communication module. Terminal 20 may be referred to as a UE.

IAB node 10A may be connected to a Core Network (CN) through a fiber Backhaul (BH). The connection to the CN is not limited only to that through an optical fiber, but may be any means capable of transmitting and receiving data. Note also that the transmission/reception means between IAB node 10A and the core network or the like may be a means using high-capacity radio.

Incidentally, the number of IAB nodes 10 and the number of terminals 20 included in radio communication system 1 are not limited to the example of FIG. 1. For example, the number of parent IAB nodes 10A connected to IAB node JOB may be two or more. Further, another child IAB node which is not illustrated in FIG. 1 may be connected to IAB node 10B. Furthermore, the number of terminals 20 connected to IAB node 10B may be two or more.

### <IAB Node>

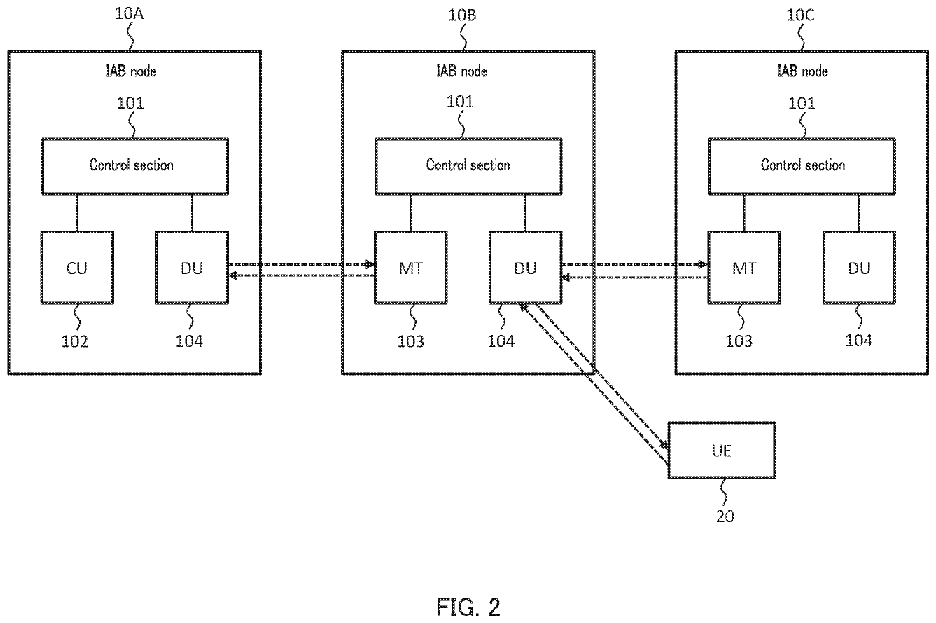

FIG. 2 illustrates exemplary configurations of IAB nodes 10. As illustrated in FIG. 2, IAB node 10A includes control section 101, Control Unit (CU) 102, and DU 104.

Each of IAB nodes 10B and 10C includes control section 101, MT 103, and DU 104. CU 102, MT 103, and DU 104 may be functional blocks.

Hereinafter, a function of CU 102 may be expressed as “CU” without the reference sign. Further, a function of MT 103 may be expressed as “MT” without the reference sign. Furthermore, a function of DU 104 may be expressed as “DU” without the reference sign. Besides, DU 104 may have a function corresponding to that of the base station or an extension station. One example of MT 103 may have a function corresponding to that of the terminal.

IAB node 10B is connected to an upstream IAB node (in FIG. 2, IAB node 10A) by MT 103. That is, MT 103 of IAB node 10B handles connection to parent IAB node 10A.

IAB node 10B is connected to UE 20 and an MT of downstream IAB node 10C by DU 103. That is, DU 104 of IAB node 10B handles connection to UE 20 and child IAB node 10C. The connection to UE 20 and/or child IAB node 10C by DU 104 is, for example, establishment of a Radio Resource Control (RRC) channel.

Control section 101 controls MT 103 (CU 102 for IAB node 10A) and DU 104. In particular, control section 101 determines a timing mode (e.g., timing mode for Case #1, timing mode for Case #6, or timing mode for Case #7), based on configuration/indication received from the parent node.

Operation of IAB node 10 described below may be implemented by control section 101 controlling MT 103 (CU 102 for IAB node 10A) and DU 104. Control section 101 may also be provided with a storage section for storing therein a variety of information.

MT 103 performs communication with the parent node in a backhaul link to the parent node (hereinafter referred to as “parent link”). DU 104 performs communication with a child node and/or a terminal in a backhaul link to the child node and/or in an access link with the terminal. Hereinafter, the backhaul link to the child node and/or the access link to the terminal are referred to as a “child link.”

A half-duplex constraint may be applied between the parent link and each of the child links. In Release 16 of 3GPP, in order to realize the half-duplex constraint, time division multiplexing (TDM) may be applied to the parent link and the child link. In this case, either the parent link or the child link may be available to utilize time resources.

Application of SDM and FDM has been studied in Release 17 and a later release. A simultaneous transmission and a simultaneous reception by an IAB-MT and an IAB-DU, and the like have been discussed on a case where the IAB-MT and the IAB-DU share a single antenna panel, transceiver, or the like by applying the SDM and the FDM.

Time resources on the parent link (hereinafter referred to as “MT resources”) are configured with one of the following types.
An MT resource configured with a DL type (hereinafter referred to as “MT-D” or simply “D”) is used as L_{P,DL} illustrated in FIG. 1;
An MT resource configured with a UL type (hereinafter referred to as “MT-U” or simply “U”) is used as L_{P,UL} illustrated in FIG. 1; and
An MT resource configured with a Flexible (FL) type (hereinafter referred to as “MT-F” or simply “F”) is used as L_{P,DL} or L_{P,UL} illustrated in FIG. 1.

The MT resources may be replaced by another expression such as resources used for communication with parent IAB node 10A, resources used for communication with parent IAB node 10A over the backhaul link, or resources used for communication with a serving cell.

Time resources on the child link (hereinafter referred to as “DU resources”) are configured with one of the following types.
A DU resource configured with the DL type (hereinafter referred to as “DU-D” or simply “D”) may be used as L_{C,DL} or L_{A,DL} illustrated in FIG. 1;
A DU resource configured with the UL type (hereinafter referred to as “DU-U” or simply “U”) may be used as L_{C,UL} or L_{A,UL} illustrated in FIG. 1; and
A DU resource configured with the FL type (hereinafter referred to as “DU-F” or simply “F”) may be used as L_{C,DL}, L_{C,UL}, L_{A,DL}, or L_{A,UL} illustrated in FIG. 1.

The DU resources may be replaced by another expression such as resources used for communication with child IAB node 10C and/or UE 20, or resources used for communication with child IAB node 10C over the backhaul link and/or with UE 20 over the access link.

Further, DU-D, DU-U, and DU-F are configured with any of the following types.
A DU resource configured with a Hard type (hereinafter may be referred to as “H”) is used for the child link but not for the parent link. Hereafter, the DU resource configured with the Hard type may be referred to as “DU(H)”;
Explicit and/or implicit indication from parent IAB node 10A determines whether a DU resource configured with a Soft type (hereinafter may be referred to as “S”) is available for the child link (hereinafter referred to as “Availability”). Hereafter, the DU resource configured with the Soft type may be referred to as “DU(S)”; and
A DU resource configured with a Not-Available (NA) type (hereinafter may be referred to as “NA”) is not used for the child link. Hereafter, the DU resource configured with the NA type may be referred to as “DU(NA).”

Note that, availability (available or not available) is specified within the DU(S).

Note that the configuration of D, U, and F, and the configuration of H, S, and NA for the DU resources may be semi-statically performed. For example, these configurations for the DU may be configured by an RRC parameter. The RRC parameter may be replaced with another term such as RRC signaling, an RRC message, or RRC configuration. These configurations for the DU may also be configured by an F1-AP parameter. The F1-AP parameter may be replaced with another term such as F1-AP signaling or an F1-AP message.

The above-mentioned configurations/indications for/to the DU resources may be referred to as Release 16 H/S/NA configuration and soft resource availability indication for the DU.

The type/availability may be configured/indicated for/to frequency resources on the parent link and the child link in the same manner as the time resources. The configurations/indications for/to DU frequency resources may be referred to as Release 17 frequency domain H/S/NA configuration and soft resource availability indication for the DU.

### <Guard Symbol>

A timing-lag between transmission and/or reception by an MT (MT Tx/Rx) and transmission and/or reception by a DU (DU Tx/Rx) may cause a contention (conflict) of resources (e.g., symbols, slots, or frames). In Release 16, in order to avoid the resource contention, a guard symbol is introduced to a transition portion between the MT Tx/Rx and the DU Tx/Rx (e.g., see NPL 2 and 3GPP TS 38.821 V16.5.0).

Incidentally, the contention may be referred to as overlapping. The transition between the MT Tx/Rx and the DU Tx/Rx may be referred to as switching between the MT and the DU or switching between an MT function and a DU function.

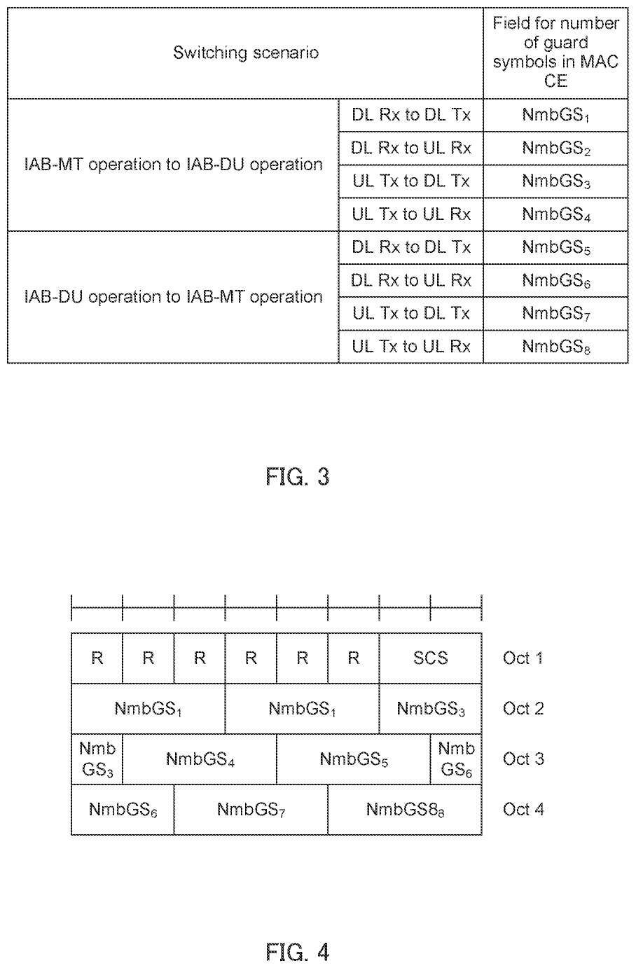

FIG. 3 is a diagram for describing scenarios of operation switching between the MT and the DU. As illustrated in FIG. 3, the operation switching between the MT and the DU includes eight scenarios. For example, operation switching from the MT to the DU includes the following four scenarios: switching from DL Rx to DL Tx; switching from DL Rx to UL Rx; switching from UL Tx to DL Tx; and switching from UL Tx to UL Rx. Operation switching from the DU to the MT also includes four scenarios as illustrated in FIG. 3.

As illustrated in the right column of FIG. 3, guard symbols NmbGS₁ to NmbGSs are configured for the respective scenarios. The parent node indicates the number of guard symbols through a Medium Access Control Control Element (MAC CE). IAB nodes indicate, to the parent node, the number of required guard symbols through the MAC CE.

FIG. 4 illustrates an exemplary MAC CE used for guard symbol indication. The parent node and the IAB nodes indicate the number of guard symbols by using fields for NmbGS₁ to NmbGSs of the MAC CE illustrated in FIG. 4. Guard symbol NmbGS₁ to NmbGSs in the eight scenarios illustrated in FIG. 3 are indicated in the fields for NmbGS₁ to NmbGSs field illustrated in FIG. 4.

### <Timing Mode>

In Release 16, a timing mode for Case #1 is supported. In Case #1, DL Tx timings between IAB nodes are aligned.

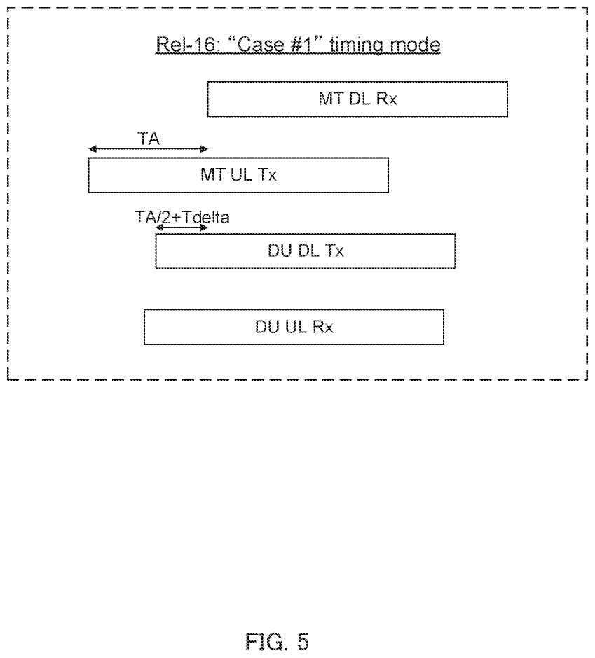

FIG. 5 illustrates an exemplary Case #1 timing mode. In Case #1, as illustrated in FIG. 5, in MT UL Tx, transmission is started earlier by TA time than the reception start time in MT DL Rx. The TA corresponds to the time obtained by adding a switching time between transmission and reception by the parent node to twice propagation time (latency) of MT DL Rx (signal).

In DU DL Tx, transmission is started earlier by TA/2+Tdelta than the reception start time in the MT DL Rx. Tdelta corresponds to a half of the switching time between transmission and reception by the parent node.

That is, in the DU DL Tx, transmission is started earlier by propagation time of the MT DL Rx+Tdelta time than the reception start time in the MT DL Rx. This aligns DL Tx timings between the IAB nodes.

As described above, in Release 17, for the purpose of supporting a simultaneous Tx or a simultaneous Rx, a timing mode for Case #6 and a timing mode for Case #7 are supported.

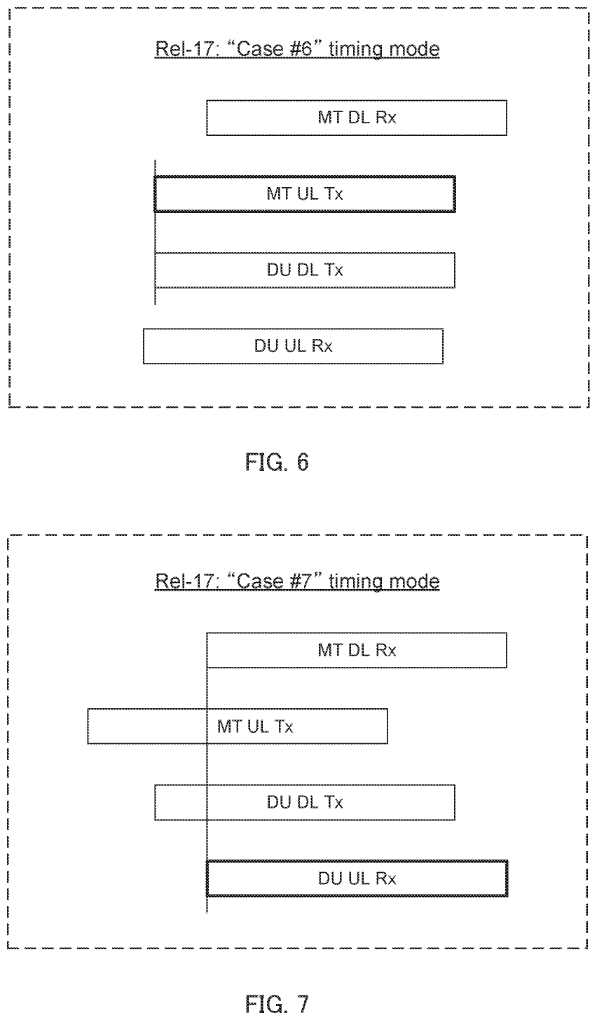

FIG. 6 illustrates an exemplary Case #6 timing mode. In Case #6, as illustrated in FIG. 6, timings for the MT and the DU in a simultaneous transmission are aligned. For example, an IAB node shifts a transmission timing for the IAB-MT (MT UL Tx in FIG. 6) to align the transmission timing for the IAB-MT with a transmission timing for the IAB-DU in which a transmission timing cannot be changed (DU DL Tx in FIG. 6).

FIG. 7 illustrates an exemplary Case #7 timing mode. In Case #7, as illustrated in FIG. 7, timings for the MT and the DU in a simultaneous reception are aligned. For example, an IAB node shifts, by shifting a transmission timing for a subordinate (lower) child node or a terminal, a reception timing for the IAB-DU (DU UL Rx in FIG. 7) so as to align the reception timing for the IAB-DU with a reception timing for the IAB-MT in which a reception timing cannot be changed (MT DL Rx in FIG. 7).

### <Guard Symbol Enhancement>

In 3GPP, further studies have been carried on the number of guard symbols required for switching between multiplexing modes (see <Problems and Analysis> below).

It has been discussed that, in each timing mode, guard symbols are reported from IAB nodes to a parent node and/or provided by the parent node to the IAB nodes. It has been also discussed that the number of guard symbols is determined in relation to a transition between an MT Tx/Rx in a particular timing mode and a DU Tx/Rx in a particular timing mode.

It has been discussed that, in each multiplexing mode, guard symbols are reported from IAB nodes to a parent node and/or provided by the parent node to the IAB nodes. It has been also discussed that the number of guard symbols is determined in relation to a transition between a multiplexing mode and another multiplexing mode.

Besides, in 3GPP, it has been agreed that a parent node is dynamically provided with conditions and parameters for facilitating adaptation between multiplexing operation modes. However, the following four matters remain For Further Study (FFS).
Number of required guard symbols for switching between multiplexing modes (FFS: per timing mode or per multiplexing mode) of the IAB-DU;
Signaling procedure;
Guard band required for the FDM; and
Additional conditions, e.g., a required timing mode, a required power control parameter, and preferred Transmission Configuration Indication (TCI).

### <Problems and Analysis>

The multiplexing mode includes the following modes.
MT Tx only;
MT Rx only;
DU Tx only;
DU Rx only;
Simultaneous MT Tx and DU Tx;
Simultaneous MT Rx and DU Rx;
Simultaneous MT Tx and DU Rx; and
Simultaneous MT Rx and DU Tx.

The multiplexing mode may be regarded as a mode of transmission/reception operation by the MT and the DU. For example, in the MT Tx only mode, an IAB node performs only MT transmission. In the simultaneous MT Tx and DU Tx mode, the IAB node simultaneously performs the MT transmission and DU transmission.

Incidentally, the top four modes may be each referred to as a single operation mode, a non-simultaneous operation mode, a single operation, or a single communication operation. The bottom four modes may be each referred to as a simultaneous operation mode, a simultaneous MT/DU operation mode, a simultaneous operation, or a simultaneous communication operation.

3GPP includes provision for switching between single operations. No provision is included, however, for switching between the single operation and the simultaneous operation, which leaves room for further study. For example, there is room for further study on switching, which has no provision, from the MT Rx only mode (single reception operation by MT) to the simultaneous MT Tx and DU Tx mode (simultaneous transmission operation by MT and DU). In the present embodiment, the switching between the single operation and the simultaneous operation is appropriately performed.

Additionally, no provision is included for switching between simultaneous operations, which leaves room for further study. For example, there is room for further study on switching, which has no provision, from the simultaneous MT Rx and DU Rx mode (simultaneous reception operation by MT and DU) to the simultaneous MT Tx and DU Tx mode (simultaneous transmission operation by MT and DU). In the present embodiment, the switching between the simultaneous operations is appropriately performed.

In addition, no provision is included for handling of guard symbols in the switching between the single operation and the simultaneous operation, which leaves room for further study. Furthermore, no provision is included for handling of guard symbols in the switching between the simultaneous operations, which leaves room for further study. In the present embodiment, the guard symbols are appropriately handled in the switching between the single operation and the simultaneous operation. Moreover, in the present embodiment, the guard symbols are appropriately handled in the switching between the simultaneous operations.

### <Proposal 1>

Whether a slot or a symbol is operated in the MT Tx/Rx only, in the DU Tx/Rx only, or in the simultaneous MT Tx/Rx and DU Tx/Rx may be determined based on the following conditions. In other words, an IAB node may determine, based on the following conditions, to switch between the single operation and the simultaneous operation or to switch between the simultaneous operations. The conditions for switching determination may be one or plural in number (e.g., combination).
Report of multiplexing capability to the parent node;
Explicit indication of multiplexing mode from the parent node;
H/S/NA resource type in time domain;
H/S/NA resource type in frequency domain;
Indication of soft resource availability in time domain;
Indication of soft resource availability in frequency domain;
Indication of a timing mode;
Indication of power control; and
Indication of a beam.

### Example 1

An IAB node may change a manner (type or form) of switching mode transition, based on the type of switching condition(s). For example, the IAB node may determine to switch from the single reception operation by the MT Rx to the simultaneous transmission operation by the MT and the DU, based on a report of multiplexing capability to the parent node. Alternatively, the IAB node may determine to switch from the simultaneous transmission operation by the MT and the DU to the single reception operation by the MT Rx, based on the H/S/NA resource type in time domain.

### Example 2

An IAB node may change a manner of the switching mode transition, based on a content of the switching condition(s). For example, when the H/S/NA resource type in time domain is the first type, the IAB node may determine to switch from the single reception operation by the MT Rx to the simultaneous transmission operation by the MT and the DU. On the other hand, when the H/S/NA resource type in time domain is the second type, the IAB node may determine to switch from the simultaneous transmission operation by the MT and the DU to the single reception operation by the MT Rx.

### <Proposal 2>

When determining to switch between the single operation and the simultaneous operation or between simultaneous operations based on the condition(s) mentioned in Proposal 1, the IAB node need not use a guard symbol in a particular resource.

Using no guard symbol may be regarded as not performing transmission or reception (communication) by the MT and/or the DU in a resource portion configured with the guard symbol. Alternatively, using no guard symbol may be regarded as not performing transmission or reception of a signal for the MT and/or the DU in the resource portion configured with the guard symbol. Alternatively, using no guard symbol may be regarded as using the resource portion configured with the guard symbol as a guard band.

### <Proposal 2-1>

In Proposal 2-1, an example will be described of using no guard symbol in a case where switching between the single operation and the simultaneous operation is determined. Examples of the switching between the single operation and the simultaneous operation include, for example, switching between the single operation by the MT and the simultaneous operation by the MT and the DU (Case 1 and Case 3) and switching between the single operation by the DU and the simultaneous operation by the MT and the DU (Case 2 and Case 4).

<Case 1: Handling of Guard Symbol in Switching from Single Operation by MT to Simultaneous Operation by MT and DU>

In Case 1, a guard symbol may be handled (processed) according to the following Alt. 1 or Alt. 2.

### Alt. 1

A guard symbol need not be used by the MT Tx/Rx (MT Tx/Rx only mode). In other words, an IAB node need not use, for Tx/Rx by an IAB-MT, a guard symbol before switching.

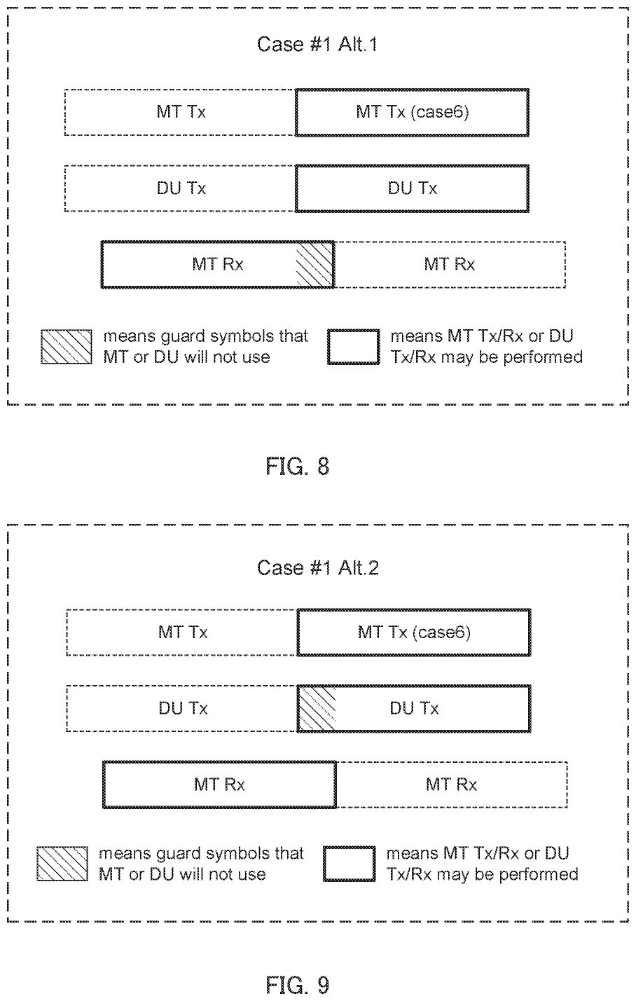

FIG. 8 is a diagram for describing an example of Alt. 1 of Case 1. As an example of Case 1, an IAB node performs switching from the single reception operation (mode) by the MT to the simultaneous transmission operation (mode) by the MT and the DU, as illustrated in FIG. 8.

As illustrated in MT Tx and DU Tx of FIG. 8, the IAB node starts the simultaneous transmission by the MT and the DU, based on a reference timing (e.g., transmission timing for DU Tx) (Case #6). A resource for the MT Rx may conflict (overlap) with a resource for the simultaneous transmission by the MT and the DU due to propagation latency.

In order to avoid the resource contention, the resource for the MT Rx is configured with a guard symbol. By way of example, a hatched portion of the MT Rx of FIG. 8 indicates a guard symbol configured for the MT Rx resource.

As mentioned above, an IAB node need not use, for Tx/Rx by an IAB-MT, a guard symbol before switching. In other words, the IAB node need not perform MT Tx/Rx in a portion configured with the guard symbol of an MT Tx/Rx resource before switching.

For example, the IAB node need not perform the MT Rx (single reception operation by MT) in the hatched portion of FIG. 8 (in portion configured with guard symbol of MT Rx resource).

### Alt. 2

A guard symbol need not be used by the DU Tx/Rx (DU Tx/Rx in simultaneous operation). In other words, an IAB node need not use, for Tx/Rx by an IAB-DU, a guard symbol after switching.

FIG. 9 is a diagram for describing an example of Alt. 2 of Case 1. As in FIG. 8, an IAB node performs switching from the single reception operation by the MT to the simultaneous transmission operation (mode) by the MT and the DU. A resource for the MT Rx may conflict with a resource for the simultaneous transmission by the MT and the DU due to propagation latency.

In order to avoid the resource contention, the resource for the DU Tx is configured with a guard symbol. By way of example, a hatched portion of the DU Tx of FIG. 9 indicates a guard symbol configured for the DU Tx resource.

As mentioned above, an IAB node need not use, for Tx/Rx by an IAB-DU, a guard symbol after switching. In other words, the IAB node need not perform DU Tx/Rx in a portion configured with the guard symbol of a DU Tx/Rx resource after switching.

For example, the IAB node need not perform the DU Tx (DU transmission operation in simultaneous transmission operation by MT and DU) in the hatched portion of FIG. 9 (in portion configured with guard symbol of DU Tx resource).

### Variation of Alt. 2

A guard symbol need not be used in the MT Tx/Rx in the simultaneous operation either. In other words, an IAB node need not use, for Tx/Rx by an IAB-MT, a guard symbol after switching.

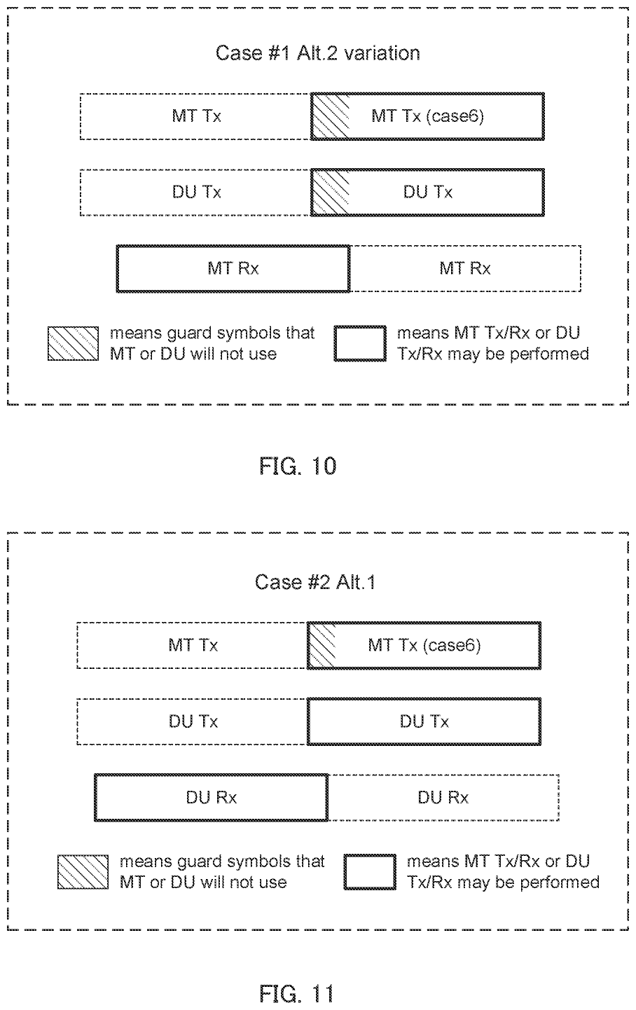

FIG. 10 is a diagram for describing an example of a variation in Alt. 2 of Case 1. As in FIG. 8, an IAB node performs switching from the single reception operation by the MT to the simultaneous transmission operation (mode) by the MT and the DU. A resource for the MT Rx may conflict with a resource for the simultaneous transmission by the MT and the DU due to propagation latency.

In order to avoid the resource contention, the resources for MT Tx and DU Tx are configured with guard symbols. By way of example, hatched portions of the MT Tx and the DU Tx of FIG. 10 indicate guard symbols configured for the MT Tx resource and the DU Tx resource.

As mentioned above, an IAB node need not use, for Tx/Rx by an IAB-MT either, a guard symbol after switching. In other words, the IAB node need not perform MT Tx/Rx and DU Tx/Rx in portions configured with the guard symbols of an MT Tx/Rx resource and a DU Tx/Rx resource after switching.

For example, the IAB node need not perform the MT Tx and the DU Tx (simultaneous transmission operation by MT and DU) in the hatched portions of FIG. 10 (in portions configured with guard symbols of MT Tx resource and DU Tx resource).

<Case 2: Handling of Guard Symbol in Switching from Single Operation by DU to Simultaneous Operation by MT and DU>

In Case 2, a guard symbol may be handled according to the following Alt. 1 or Alt. 2.

### Alt. 1

A guard symbol need not be used by the MT Tx/Rx (MT Tx/Rx in simultaneous operation). In other words, an IAB node need not use, for Tx/Rx by an IAB-MT, a guard symbol after switching.

FIG. 11 is a diagram for describing an example of Alt. 1 of Case 2. As an example of Case 2, an IAB node performs switching from the single reception operation by the DU to the simultaneous transmission operation by the MT and the DU, as illustrated in FIG. 11.

As illustrated in MT Tx and DU Tx of FIG. 11, the IAB node starts the simultaneous transmission by the MT and the DU, based on a reference timing (e.g., transmission timing for DU Tx) (Case #6). A resource for the DU Rx may conflict with a resource for the simultaneous transmission by the MT and the DU due to propagation latency.

In order to avoid the resource contention, the resource for the MT Tx is configured with a guard symbol. By way of example, a hatched portion of the MT Tx of FIG. 11 indicates a guard symbol configured for the MT Tx resource.

As mentioned above, an IAB node need not use, for Tx/Rx by an IAB-MT, a guard symbol after switching. In other words, the IAB node need not perform MT Tx/Rx in a portion configured with the guard symbol of an MT Tx/Rx resource after switching.

For example, the IAB node need not perform the MT Tx (MT transmission operation in simultaneous transmission operation by MT and DU) in the hatched portion of FIG. 11 (in portion configured with guard symbol of MT Tx resource).

### Variation of Alt. 1

A guard symbol need not be used in the DU Tx/Rx in the simultaneous operation either. In other words, an IAB node need not use, for Tx/Rx by an IAB-DU, a guard symbol after switching.

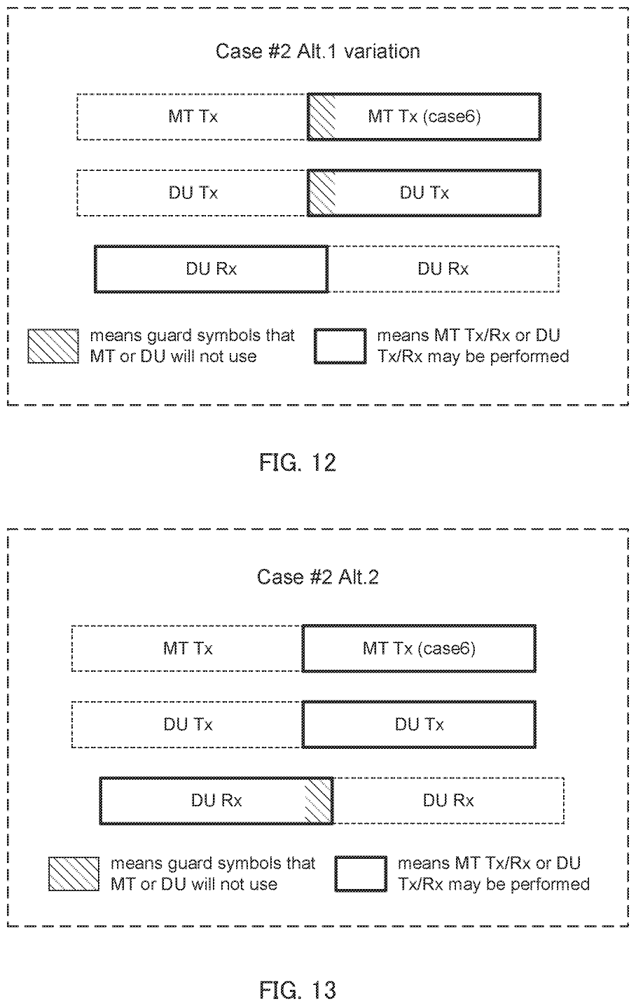

FIG. 12 is a diagram for describing an exemplary variation in Alt. 1 of Case 2. As in FIG. 11, an IAB node performs switching from the single reception operation by the DU to the simultaneous transmission operation by the MT and the DU. A resource for the DU Rx may conflict with a resource for the simultaneous transmission by the MT and the DU due to propagation latency.

In order to avoid the resource contention, the resources for MT Tx and DU Tx are configured with guard symbols. By way of example, hatched portions of the MT Tx and the DU Tx of FIG. 12 indicate guard symbols configured for the MT Tx resource and the DU Tx resource.

As mentioned above, an IAB node need not use, for Tx/Rx by an IAB-DU either, a guard symbol after switching. In other words, the IAB node need not perform MT Tx/Rx and DU Tx/Rx in portions configured with the guard symbols of an MT Tx/Rx resource and a DU Tx/Rx resource after switching.

For example, the IAB node need not perform the MT Tx and the DU Tx (simultaneous transmission operation by MT and DU) in the hatched portions of FIG. 12 (in portions configured with guard symbols of MT Tx resource and DU Tx resource).

### Alt. 2

A guard symbol need not be used by the DU Tx/Rx (DU only mode). In other words, an IAB node need not use, for Tx/Rx by an IAB-DU, a guard symbol before switching.

FIG. 13 is a diagram for describing an example of Alt. 2 of Case 2. As in FIG. 11, an IAB node performs switching from the single reception operation by the DU to the simultaneous transmission operation by the MT and the DU. A resource for the DU Rx may conflict with a resource for the simultaneous transmission by the MT and the DU due to propagation latency.

In order to avoid the resource contention, the resource for the DU Rx is configured with a guard symbol. By way of example, a hatched portion of the DU Rx of FIG. 13 indicates a guard symbol configured for the DU Rx resource.

As mentioned above, an IAB node need not use, for Tx/Rx by an LAB-DU, a guard symbol before switching. In other words, the IAB node need not perform DU Tx/Rx in a portion configured with the guard symbol of a DU Tx/Rx resource before switching.

For example, the IAB node need not perform the DU Rx (single reception operation by DU) in the hatched portion of FIG. 13 (in portion configured with guard symbol of DU Rx resource).

<Case 3: Handling of Guard Symbol in Switching from Simultaneous Operation by MT and DU to Single Operation by MT>

In Case 3, a guard symbol may be handled according to the following Alt. 1 or Alt. 2.

### Alt. 1

A guard symbol need not be used by the MT Tx/Rx (MT only mode). In other words, an IAB node need not use, for Tx/Rx by an IAB-MT, a guard symbol after switching.

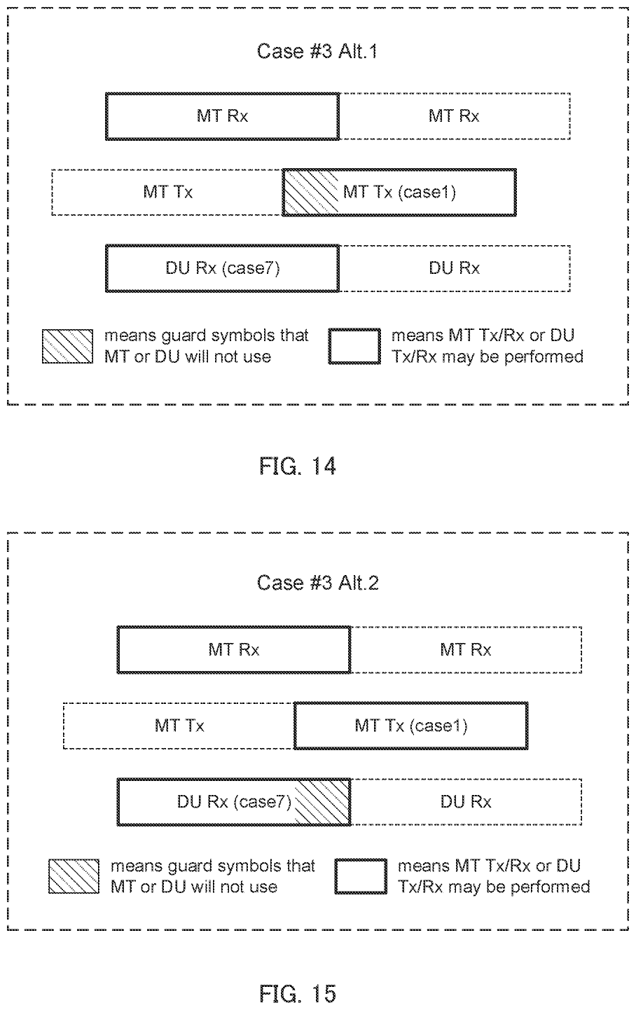

FIG. 14 is a diagram for describing an example of Alt. 1 of Case 3. As an example of Case 3, an IAB node performs switching from the simultaneous reception operation by the MT and the DU to the single transmission operation by the MT, as illustrated in FIG. 14.

As illustrated in MT Rx and DU Rx of FIG. 14, the IAB node starts the simultaneous reception by the MT and the DU, based on a reference timing (e.g., reception timing for MT Rx)(Case #7). A resource for the single transmission by the MT is adjusted in transmission timing (Case #1) in order to avoid a reception timing lag in the parent node, which may result in a contention with a resource for the simultaneous reception by the MT and the DU.

In order to avoid the resource contention, the resource for the MT Tx is configured with a guard symbol. By way of example, a hatched portion of the MT Tx of FIG. 14 indicates a guard symbol configured for the MT Tx resource.

As mentioned above, an IAB node need not use, for Tx/Rx by an IAB-MT, a guard symbol after switching. In other words, the IAB node need not perform MT Tx/Rx in a portion configured with the guard symbol of an MT Tx/Rx resource after switching.

For example, the IAB node need not perform the MT Tx (single transmission operation by MT) in the hatched portion of FIG. 14 (in portion configured with guard symbol of MT Tx resource).

### Alt. 2

A guard symbol need not be used by the DU Tx/Rx (DU Tx/Rx in simultaneous operation). In other words, an IAB node need not use, for Tx/Rx by an IAB-DU, a guard symbol before switching.

FIG. 15 is a diagram for describing an example of Alt. 2 of Case 3. As in FIG. 14, an IAB node performs switching from the simultaneous reception operation by the MT and the DU to the single transmission operation by the MT. Resources for the MT Rx and the DU Rx may conflict with a resource for the single transmission operation by the MT.

In order to avoid the resource contention, the resource for the DU Rx is configured with a guard symbol. By way of example, a hatched portion of the DU Rx of FIG. 15 indicates a guard symbol configured for the DU Rx resource.

As mentioned above, an IAB node need not use, for Tx/Rx by an IAB-DU, a guard symbol before switching. In other words, the IAB node need not perform DU Tx/Rx in a portion configured with the guard symbol of a DU Tx/Rx resource before switching.

For example, the IAB node need not perform the DU Rx (DU reception operation in simultaneous reception operation by MT and DU) in the hatched portion of FIG. 15 (in portion configured with guard symbol of DU Rx resource).

### Variation of Alt. 2

A guard symbol need not be used in the MT Tx/Rx in the simultaneous operation either. In other words, an IAB node need not use, for Tx/Rx by an IAB-MT, a guard symbol before switching.

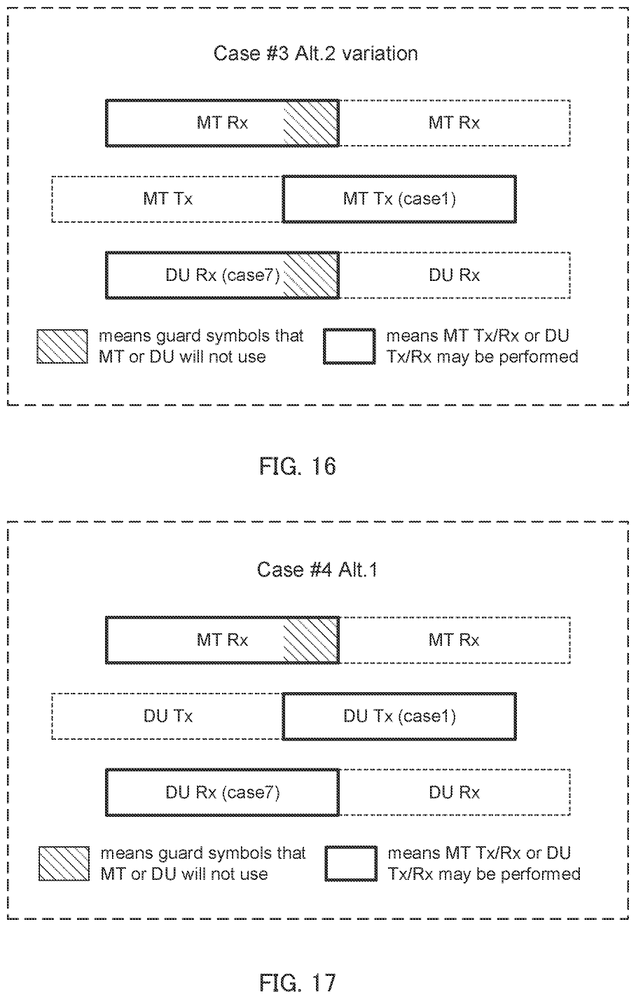

FIG. 16 is a diagram for describing an example of a variation in Alt. 2 of Case 3. As in FIG. 14, an IAB node performs switching from the simultaneous reception operation by the MT and the DU to the single transmission operation by the MT. Resources for the MT Rx and the DU Rx may conflict with a resource for the single transmission operation by the MT.

In order to avoid the resource contention, the resources for the MT Rx and the DU Rx are configured with guard symbols. By way of example, hatched portions of the MT Rx and the DU Rx of FIG. 16 indicate guard symbols configured for the MT Rx resource and the DU Rx resource.

As mentioned above, an IAB node need not use, for Tx/Rx by an IAB-MT, a guard symbol before switching. In other words, the IAB node need not perform MT Tx/Rx and DU Tx/Rx in portions configured with the guard symbols of an MT Tx/Rx resource and a DU Tx/Rx resource before switching.

For example, the IAB node need not perform the MT Tx/Rx and the DU Rx (simultaneous reception operation by MT and DU) in the hatched portions of FIG. 16 (in portions configured with guard symbols of MT Rx resource and DU Rx resource).

<Case 4: Handling of Guard Symbol in Switching from Simultaneous Operation by MT and DU to Single Operation by DU>

In Case 4, a guard symbol may be handled according to the following Alt. 1 or Alt. 2.

### Alt. 1

A guard symbol need not be used by the MT Tx/Rx (MT Tx/Rx in simultaneous operation). In other words, an IAB node need not use, for Tx/Rx by an IAB-MT, a guard symbol before switching.

FIG. 17 is a diagram for describing an example of Alt. 1 of Case 4. As an example of Case 4, an IAB node performs switching from the simultaneous reception operation by the MT and the DU to the single transmission operation by the DU, as illustrated in FIG. 17.

As illustrated in MT Rx and DU Rx of FIG. 17, the IAB node starts the simultaneous reception by the MT and the DU, based on a reference timing (e.g., reception timing for MT Rx) (Case #7). A resource for the single transmission by the DU is adjusted in transmission timing (Case #1) in order to avoid a DL Tx timing lag between IAB nodes, which may result in a contention with a resource for the simultaneous reception by the MT and the DU.

In order to avoid the resource contention, the resource for the MT Rx is configured with a guard symbol. By way of example, a hatched portion of the MT Rx of FIG. 17 indicates a guard symbol configured for the MT Rx resource.

As mentioned above, an IAB node need not use, for Tx/Rx by an IAB-MT, a guard symbol before switching. In other words, the IAB node need not perform MT Tx/Rx in a portion configured with the guard symbol of an MT Tx/Rx resource before switching.

For example, the IAB node need not perform the MT Rx (MT reception operation in simultaneous reception operation by MT and DU) in the hatched portion of FIG. 17 (in portion configured with guard symbol of MT Rx resource).

### Variation of Alt. 1

A guard symbol need not be used in the DU Tx/Rx in the simultaneous operation either. In other words, an IAB node need not use, for Tx/Rx by an IAB-DU, a guard symbol before switching.

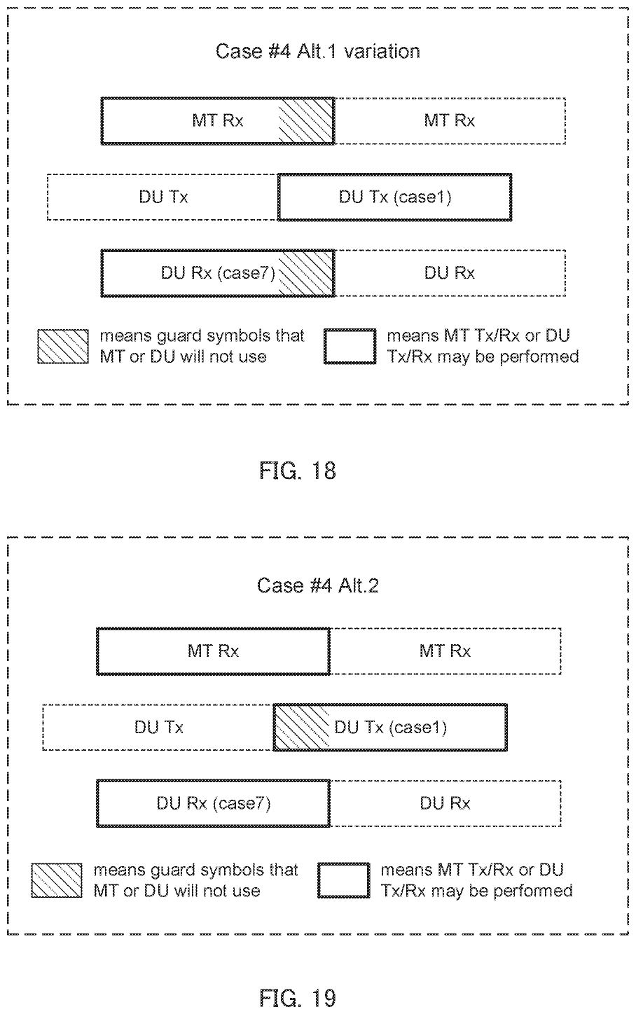

FIG. 18 is a diagram for describing an example of a variation in Alt. 1 of Case 4. As in FIG. 17, an IAB node performs switching from the simultaneous reception operation by the MT and the DU to the single transmission operation by the DU. Resources for the MT Rx and the DU Rx may conflict with a resource for the single transmission operation by the DU.

In order to avoid the resource contention, the resources for the MT Rx and the DU Rx are configured with guard symbols. By way of example, hatched portions of the MT Rx and the DU Rx of FIG. 18 indicate guard symbols configured for the MT Rx resource and the DU Rx resource.

As mentioned above, an IAB node need not use, for Tx/Rx by an IAB-DU, a guard symbol before switching. In other words, the IAB node need not perform MT Tx/Rx and DU Tx/Rx in portions configured with the guard symbols of an MT Tx/Rx resource and a DU Tx/Rx resource before switching.

For example, the IAB node need not perform the MT Tx/Rx and the DU Rx (simultaneous reception operation by MT and DU) in the hatched portions of FIG. 18 (in portions configured with guard symbols of MT Rx resource and DU Rx resource).

### Alt. 2

A guard symbol need not be used by the DU Tx/Rx (DU only mode). In other words, an IAB node need not use, for Tx/Rx by an IAB-DU, a guard symbol after switching.

FIG. 19 is a diagram for describing an example of Alt. 2 of Case 4. As in FIG. 17, an LAB node performs switching from the simultaneous reception operation by the MT and the DU to the single transmission operation by the DU. A resource for the DU Tx may conflict with a resource for the simultaneous reception by the MT and the DU.

In order to avoid the resource contention, the resource for the DU Tx is configured with a guard symbol. By way of example, a hatched portion of the DU Tx of FIG. 19 indicates a guard symbol configured for the DU Tx resource.

As mentioned above, an IAB node need not use, for Tx/Rx by an IAB-DU, a guard symbol after switching. In other words, the IAB node need not perform DU Tx/Rx in a portion configured with the guard symbol of a DU Tx/Rx resource after switching.

For example, the IAB node need not perform the DU Tx (single transmission operation by DU) in the hatched portion of FIG. 19 (in portion configured with guard symbol of DU Tx resource).

Incidentally, Alt. 1 or Alt. 2 may be differently supported in the above-mentioned four cases. For example, Alt 1 may be supported in Case 1 and Case 3, and Alt 2 may be supported in Case 2 and Case 4.

### <Proposal 2-2>

In Proposal 2-2, an example will be described of using no guard symbol in a case where switching between simultaneous operations is determined. In switching between the simultaneous operations, the following guard symbols (the number of guard symbols) are assumed.
Assume that the number of symbols of guard symbol #1 is determined for transition between MT Tx/Rx in a slot before switching and DU Tx/Rx in a slot after switching.
Assume that the number of symbols of guard symbol #2 is determined for transition between DU Tx/Rx in a slot before switching and MT Tx/Rx in a slot after switching.

Incidentally, when a guard symbol is configured for each multiplexing mode, the number of symbols of guard symbol #1 and the number of symbols of guard symbol #2 may be identical with each other.

In a case where switching between the simultaneous reception operation by the MT and the DU and the simultaneous transmission operation by the MT and the DU is perfumed while guard symbol #1 is used for switching from the MT to the DU, a guard symbol may be handled according to the following Alt. 1 or Alt. 2.

### Alt. 1

Guard symbol #1 need not be used by the MT Tx/Rx (MT Tx/Rx in slot before switching). In other words, an IAB node need not use, for Tx/Rx by an IAB-MT, guard symbol #1 before switching.

### Variation of Alt. 1

A guard symbol need not be used in the DU Tx/Rx in a slot before switching either. In other words, an IAB node need not use, for Tx/Rx by an IAB-DU, a guard symbol before switching.

### Alt. 2

Guard symbol #1 need not be used by the DU Tx/Rx (DU Tx/Rx in slot after switching). In other words, an IAB node need not use, for Tx/Rx by an IAB-DU, guard symbol #1 after switching.

### Variation of Alt. 2

A guard symbol need not be used in the MT Tx/Rx in a slot after switching either. In other words, an IAB node need not use, for Tx/Rx by an IAB-MT, a guard symbol after switching.

In a case where switching between the simultaneous reception operation by the MT and the DU and the simultaneous transmission operation by the MT and the DU is performed while guard symbol #2 is used for switching from the DU to the MT, a guard symbol may be handled according to the following Opt. 1 or Opt. 2.

### Opt. 1

Guard symbol #2 need not be used by the MT Tx/Rx (MT Tx/Rx in slot after switching). In other words, an IAB node need not use, for Tx/Rx by an IAB-MT, guard symbol #2 after switching.

### Variation of Opt. 1

A guard symbol need not be used in the DU Tx/Rx in a slot before switching either. In other words, an IAB node need not use, for Tx/Rx by an IAB-DU, a guard symbol before switching.

### Opt. 2

Guard symbol #2 need not be used by the DU Tx/Rx (DU Tx/Rx in slot before switching). In other words, an IAB node need not use, for Tx/Rx by an IAB-DU, guard symbol #2 before switching.

### Variation of Opt. 2

A guard symbol need not be used in the MT Tx/Rx in a slot after switching either. In other words, an IAB node need not use, for Tx/Rx by an IAB-MT, a guard symbol after switching.

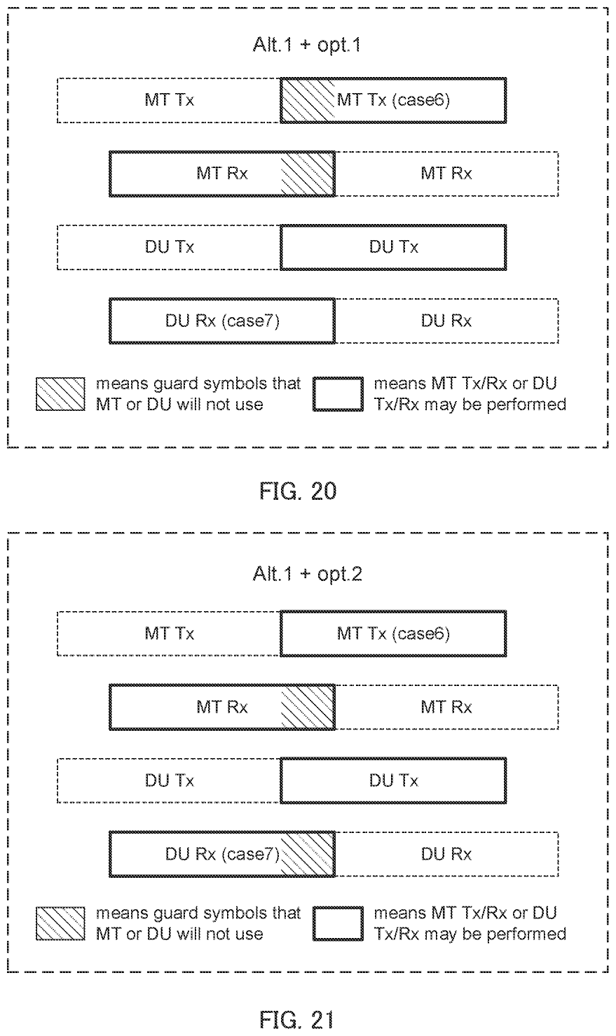

FIG. 20 is a diagram for describing an example of Alt.1+Opt.1 in Proposal 2-2. An IAB node performs switching from the simultaneous reception operation by the MT and the DU (Case #7) to the simultaneous transmission operation by the MT and the DU (Case #6).

As mentioned above, in Alt. 1, an IAB node need not use, for Tx/Rx by an IAB-MT, guard symbol #1 before switching. For example, the IAB node need not perform MT Rx (MT reception operation in simultaneous reception operation by MT and DU) in the hatched portion of the MT Rx resource of FIG. 20 (in guard symbol #1 before switching).

Meanwhile, as mentioned above, in Opt. 1, an IAB node need not use, for Tx/Rx by an IAB-MT, guard symbol #2 after switching. For example, the IAB node need not perform MT Tx (MT transmission operation in simultaneous transmission operation by MT and DU) in the hatched portion of the MT Tx resource of FIG. 20 (in guard symbol #2 after switching).

FIG. 21 is a diagram for describing an example of Alt.1+Opt. 2 in Proposal 2-2. As in FIG. 20, an IAB node performs switching from the simultaneous reception operation by the MT and the DU to the simultaneous transmission operation by the MT and the DU.

As mentioned above, in Alt. 1, an IAB node need not use, for Tx/Rx by an IAB-MT, guard symbol #1 before switching. For example, the IAB node need not perform MT Rx (MT reception operation in simultaneous reception operation by MT and DU) in the hatched portion of the MT Rx resource of FIG. 21 (in guard symbol #1 before switching).

Meanwhile, as mentioned above, in Opt. 2, an IAB node need not use, for Tx/Rx by an IAB-DU, guard symbol #2 before switching. For example, the IAB node need not perform DU Rx (DU reception operation in simultaneous reception operation by MT and DU) in the hatched portion of the DU Rx resource of FIG. 21 (in guard symbol #2 before switching).

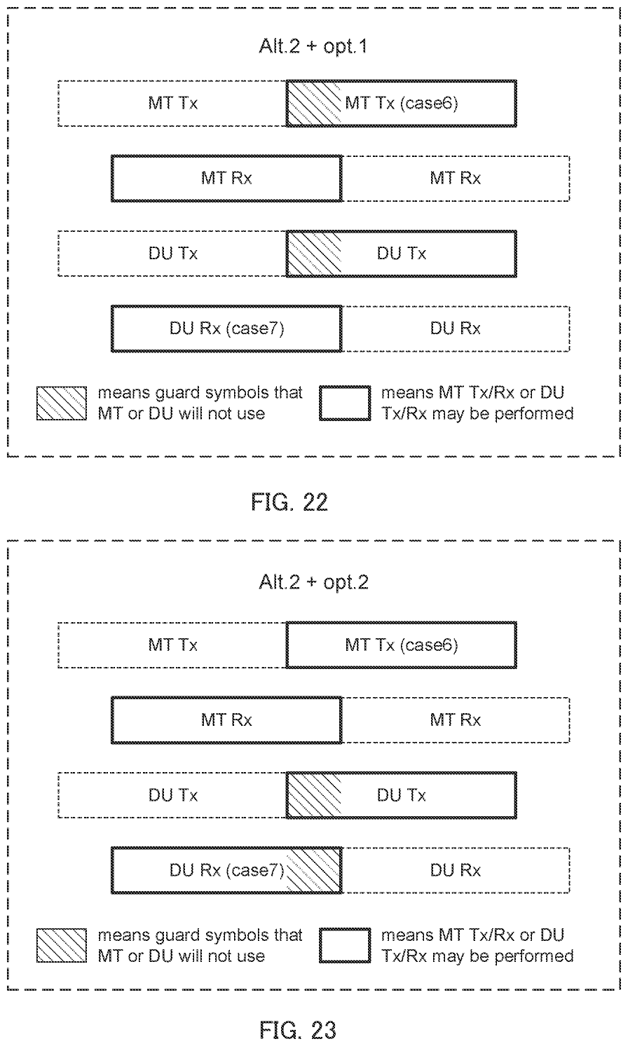

FIG. 22 is a diagram for describing an example of Alt. 2+Opt. 1 in Proposal 2-2. As in FIG. 20, an IAB node performs switching from the simultaneous reception operation by the MT and the DU to the simultaneous transmission operation by the MT and the DU.

As mentioned above, in Alt. 2, an IAB node need not use, for Tx/Rx by an IAB-DU, guard symbol #1 after switching. For example, the IAB node need not perform DU Tx (DU transmission operation in simultaneous transmission operation by MT and DU) in the hatched portion of the DU Tx resource of FIG. 22 (in guard symbol #1 after switching).

Meanwhile, as mentioned above, in Opt. 1, an IAB node need not use, for Tx/Rx by an IAB-MT, guard symbol #2 after switching. For example, the IAB node need not perform MT Tx (MT transmission operation in simultaneous transmission operation by MT and DU) in the hatched portion of the MT Tx resource of FIG. 20 (in guard symbol #2 after switching).

FIG. 23 is a diagram for describing an example of Alt. 2+Opt. 2 in Proposal 2-2. As in FIG. 20, an IAB node performs switching from the simultaneous reception operation by the MT and the DU to the simultaneous transmission operation by the MT and the DU.

As mentioned above, in Alt. 2, an JAB node need not use, for Tx/Rx by an IAB-DU, guard symbol #1 after switching. For example, the IAB node need not perform DU Tx (DU transmission operation in simultaneous transmission operation by MT and DU) in the hatched portion of the DU Tx resource of FIG. 23 (in guard symbol #1 after switching).

Meanwhile, as mentioned above, in Opt. 2, an IAB node need not use, for Tx/Rx by an IAB-DU, guard symbol #2 before switching. For example, the IAB node need not perform DU Rx (DU reception operation in simultaneous reception operation by MT and DU) in the hatched portion of the DU Rx resource of FIG. 23 (in guard symbol #2 before switching).

Alt. 1/2 and Opt. 1/2 may be modified in terms of support and application under various conditions. For example, Alt. 1/2 and Opt. 1/2 may be modified in terms of support and application depending on whether guard symbol #1 is greater or less than guard symbol #2.

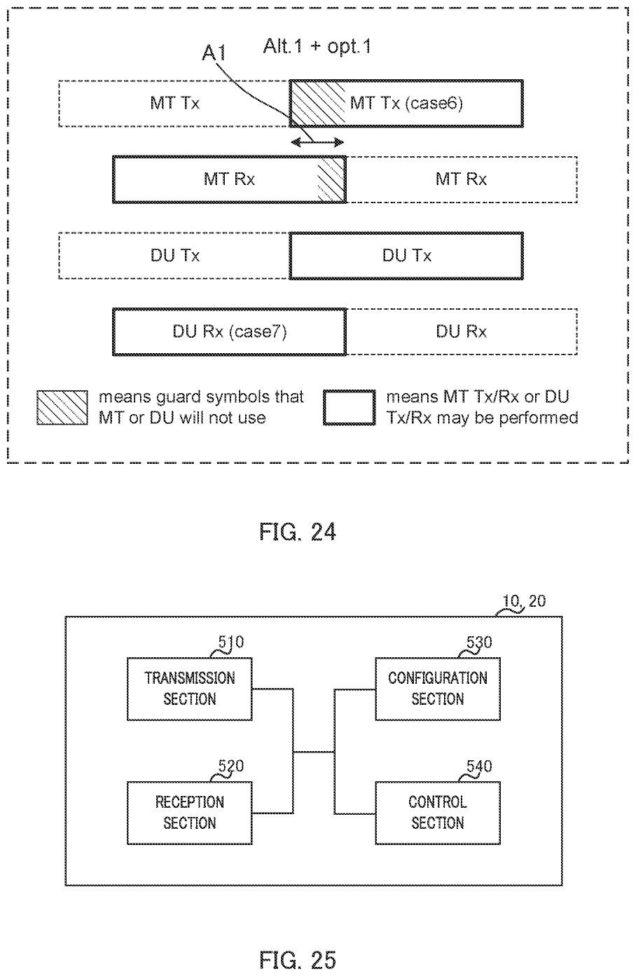

FIG. 24 is a diagram for describing an exemplary modification in terms of support and application. FIG. 24 illustrates an example of Alt. 1+Opt. 1 in Proposal 2-2 illustrated in FIG. 20. FIG. 24 is, however, different in size of guard symbol #1 in the MT Rx resource illustrated in FIG. 20. A different number of symbols may be configured for guard symbols #1 and #2, as illustrated in FIG. 24.

In FIG. 24, guard symbol #1 in the MT Rx resource is less than guard symbol #2 in the MT Tx resource. In this case, an IAB node may apply guard symbol #2 having a larger guard symbol to the MT Rx resource having a smaller number of guard symbols and need not perform the MT Rx in a portion of the MT Rx resource to which guard symbol #2 is applied (in resource portion indicated by double-headed arrow A1 illustrated in FIG. 24).

### <IAB Node Capability and Higher Layer Signaling>

IAB node capability indicating capability of an IAB node may include the following pieces of information on the LAB node capability. Note that the information indicating the IAB node capability may correspond to information defining the IAB node capability. The information indicating the IAB node capability may be given by, for example, higher layer signaling such as RRC.
Information on whether Case #6 timing or Case #7 timing is supported or not;
Information on whether simultaneous MT Tx and DU Tx, simultaneous MT Rx and DU Rx, simultaneous MT Tx and DU Rx, or simultaneous MT Rx and DU Tx is supported or not; and
Information on whether a guard symbol is supported or not per timing mode or per multiplexing mode.

The above proposals may be applied when the IAB node capability is supported and/or enabled by higher layer signaling.

### <Options>

### Option 1

In Case 1 of Proposal 2-1, a guard symbol need not be used by MT Tx/Rx (MT Tx/Rx in simultaneous operation). In other words, an IAB node need not use, for Tx/Rx by an IAB-MT, a guard symbol after switching.

For example, as an example of Case 1, let us assume switching from the single reception operation by the MT to the simultaneous transmission operation by the MT and the DU. In this situation, an IAB node need not perform MT Tx in a portion configured with a guard symbol of an MT Tx resource after switching.

### Option 2

In Case 2 of Proposal 2-1, a guard symbol need not be used by DU Tx/Rx (DU Tx/Rx in simultaneous operation). In other words, an IAB node need not use, for Tx/Rx by an IAB-DU, a guard symbol after switching.

For example, as an example of Case 2, let us assume switching from the single reception operation by the DU to the simultaneous transmission operation by the MT and the DU. In this situation, an IAB node need not perform DU Tx in a portion configured with a guard symbol of a DU Tx resource after switching.

### Option 3

In Case 3 of Proposal 2-1, a guard symbol need not be used by the MT Tx/Rx (MT Tx/Rx in simultaneous operation). In other words, an LAB node need not use, for Tx/Rx by an LAB-MT, a guard symbol before switching.

For example, as an example of Case 3, let us assume switching from the simultaneous reception operation by the MT and the DU to the single transmission operation by the MT. In this situation, an IAB node need not perform MT Rx in a portion configured with a guard symbol of an MT Rx resource before switching.

### Option 4

In Case 4 of Proposal 2-1, a guard symbol need not be used by DU Tx/Rx (DU Tx/Rx in simultaneous operation). In other words, an IAB node need not use, for Tx/Rx by an IAB-DU, a guard symbol before switching.

For example, as an example of Case 4, let us assume switching from the simultaneous reception operation by the MT and the DU to the single transmission operation by the DU. In this situation, an IAB node need not perform DU Rx in a portion configured with a guard symbol of a DU Rx resource before switching.

### Option 5

An IAB node may select (switch) any Alt. and Opt. described in Proposal 2, based on the switching condition(s) described in Proposal 1. For example, the IAB node may select any Alt. and Opt. described in Proposal 2, based on the type of switching condition(s) described in Proposal 1. Alternatively, the IAB node may select any Alt. and Opt. described in Proposal 2, based on a content of the switching condition(s) described in Proposal 1.

### <Functions of IAB Node and Terminal>

FIG. 25 illustrates an exemplary functional configuration of IAB node 10 or terminal according to an embodiment of the present disclosure. As illustrated in FIG. 25, IAB node 10 and terminal 20 each include transmission section 510, reception section 520, configuration section 530, and control section 540. The functional configuration illustrated in FIG. 25 is merely an example. Any names may be used for the function categories and functional sections as long as they are capable of performing an operation according to an embodiment of the present disclosure.

Transmission section 510 generates a transmission signal from transmission data, and transmits the generated transmission signal by radio. Reception section 520 receives various types of signals by radio, and acquires a higher layer signal from the received physical layer signal. With respect to IAB node 10, transmission section 510 and reception section 520 are illustrated in one block, but transmission section 510 and reception section 520 may be included in each of an IAB-MT (IAB-CU) and an IAB-DU. Transmission section 510 and reception section 520 may be referred to as a communication section.

Configuration section 530, for example, stores various types of configuration information received from a parent node by reception section 520 in a storage apparatus (storage section) and then reads the configuration information from the storage apparatus as needed. Configuration section 530 stores, in the storage apparatus, also configured information configured in advance. Note that configuration section 530 may be included in control section 540.

Control section 540 controls the entirety of LAB node 10 and terminal 20. The functional section relating to signal transmission in control section 540 may be included in transmission section 510, and the functional section relating to signal reception in control section 540 may be included in reception section 520.

The communication section may have a simultaneous communication operation in which first communication with a child node or a terminal and second communication with a parent node are simultaneously performed and a single communication operation in which either the first communication or the second communication is performed. The first communication may be regarded as, for example, a communication operation by the IAB-MT. The second communication may be regarded as a communication operation by the IAB-DU.

Control section 540 may determine to switch between the simultaneous communication operation and the single communication operation, based on either one of or both of a report to the parent node and indication from the parent node.

The report to the parent node may be, for example, a report of multiplexing capability. The indication from the parent node may be an explicit indication of a multiplexing mode from the parent node, an H/S/NA resource type in time domain, an H/S/NA resource type in frequency domain, indication of soft resource availability in time domain, indication of soft resource availability in frequency domain, indication of a timing mode, indication of power control, or indication of a beam.

Control section 540 may determine to switch between transmission operation and reception operation in the simultaneous communication operation, based on either one of or both of the report to the parent node and the indication from the parent node.

The communication section need not perform communication (stop communication) in a guard symbol section in a resource before switching. Alternatively, the communication section may stop communication in a guard symbol section in a resource after switching.

According to the embodiment described above, an IAB node can appropriately perform switching between the simultaneous communication operation and the single communication operation. The IAB node can appropriately perform switching between the transmission operation and the reception operation in the simultaneous communication operation. In addition, the IAB node stops communication in a guard symbol section, thereby reducing the power consumption.

The present disclosure has been described, thus far.

<Hardware Configuration and/or the Like>

Note that, the block diagrams used to describe the embodiment illustrate blocks on the basis of functions. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (for example, via wires or by radio), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmitting unit,” “transmission section,” or “transmitter.” The methods for implementing the functions are not limited specifically as described above.

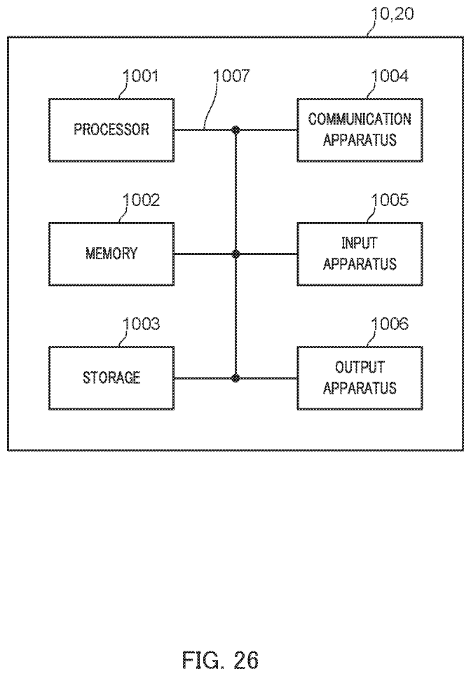

For example, the IAB node, the terminal, and the like according to an embodiment of the present disclosure may function as a computer that executes processing of a wireless communication method of the present disclosure. FIG. 26 illustrates an example of hardware configurations of the IAB node and the terminal according to an embodiment of the present disclosure. IAB node 10 and terminal 20 described above may be each physically constituted as a computer apparatus including processor 1001, memory 1002, storage 1003, communication apparatus 1004, input apparatus 1005, output apparatus 1006, bus 1007, and the like.

Note that, the term “apparatus” in the following description can be replaced with a circuit, a device, a unit, or the like. The hardware configurations of IAB node 10 and of terminal 20 may include one apparatus or a plurality of apparatuses illustrated in the drawings, or may not include part of the apparatuses.

The functions of IAB node 10 and terminal 20 are implemented by predetermined software (program)loaded into hardware such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, control section 101 and control section 540 as described above may be implemented by processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiments is used. For example, control section 540 of IAB node 10 and terminal 20 may be implemented by a control program stored in memory 1002 and operated by a control program operating in processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented using one or more chips. Note that the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called as a register, a cache, a main memory (main storage apparatus), or the like. Memory 1002 can save a program (program code), a software module, and the like that can be executed to carry out the radio communication method according to one embodiment of the present disclosure. [0210] Storage 1003 is a computer-readable recording medium and may be composed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be called as an auxiliary storage apparatus. The storage medium as described above may be, for example, a database, a server, or other appropriate media including at least one of memory 1002 and storage 1003.

Communication apparatus 1004 is hardware (transmission and reception device) for communication between computers through at least one of wired and radio networks and is also called as, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. For example, CU 102, MT 103, DU 104, transmission section 510, reception section 520, configuration section 530, and control section 540, and the like as described above may be realized by communication apparatus 1004.

Input apparatus 1005 is an input device (e.g., a keyboard, a mouse, a microphone, a switch, a button, or a sensor) that receives input from the outside. Output apparatus 1006 is an output device (e.g., a display, a speaker, or an LED lamp) which makes outputs to the outside. Note that input apparatus 1005 and output apparatus 1006 may be integrated (e.g., a touch panel).

The apparatuses, such as processor 1001, memory 1002, and the like are connected by bus 1007 for communication of information. Bus 1007 may be configured using a single bus or using buses different between each pair of the apparatuses.

Furthermore, IAB node 10 and terminal 20 may include hardware, such as a microprocessor, a digital signal processor (DSP), an ASIC (Application Specific Integrated Circuit), a PLD (Programmable Logic Device), and an FPGA (Field Programmable Gate Array), and the hardware may implement part or all of the functional blocks. For example, processor 1001 may be implemented using at least one of these pieces of hardware.

### <Notification and Signaling of Information>

The notification of information is not limited to the embodiments described in the present disclosure, and the information may be notified by another method. For example, the notification of information may be carried out by one or a combination of physical layer signaling (e.g., Downlink Control Information (DCI) and Uplink Control Information (UCI)), higher layer signaling (e.g., Radio Resource Control (RRC) signaling, Medium Access Control (MAC) signaling, broadcast information (Master Information Block (MLB), and System Information Block (SIB))), and other signals. The RRC signaling may be called an RRC message and may be, for example, an RRC connection setup message, an RRC connection reconfiguration message, or the like.

### <Applied System>

The embodiments described in the present disclosure may be applied to at least one of a system using Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended based on the above systems. Additionally or alternatively, a combination of two or more of the systems (e.g., a combination of at least LTE or LTE-A and 5G) may be applied.

<Processing Procedure and/or the Like>

The orders of the processing procedures, the sequences, the flow charts, and the like of the aspects and embodiments described in the present disclosure may be changed as long as there is no contradiction. For example, elements of various steps are presented in exemplary orders in the methods described in the present disclosure, and the methods are not limited to the presented specific orders.

### <Operation of Base Station>

Specific operations which are described in the present disclosure as being performed by the base station may sometimes be performed by a higher node (upper node) depending on the situation. Various operations performed for communication with a terminal in a network constituted by one network node or a plurality of network nodes including a base station can be obviously performed by at least one of the base station and a network node other than the base station (examples include, but not limited to, Mobility Management Entity (MME) or Serving Gateway (S-GW)). Although there is one network node in addition to the base station in the case illustrated above, a plurality of other network nodes may be combined (e.g., MME and S-GW).

### <Direction of Input and Output>

The information or the like (see the item of “Information and Signals”) can be output from a higher layer (or a lower layer) to a lower layer (or a higher layer). The information, the signals, and the like may be input and output through a plurality of network nodes.

### <Handling of Input and Output Information and the Like>

The input and output information and the like may be saved in a specific place (e.g., memory) or may be managed using a management table. The input and output information and the like can be overwritten, updated, or additionally written. The output information and the like may be deleted. The input information and the like may be transmitted to another apparatus.

### <Determination Method>

The determination may be made based on a value expressed by one bit (0 or 1), based on a Boolean value (true or false), or based on comparison with a numerical value (e.g., comparison with a predetermined value).

### VARIATIONS AND THE LIKE OF ASPECTS

The aspects and embodiments described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

### <Software>

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (e.g., a coaxial cable, an optical fiber cable, a twisted pair, and a digital subscriber line (DSL)) and a radio technique (e.g., an infrared ray and a microwave), the at least one of the wired technique and the radio technique is included in the definition of the transmission medium.

### <Information and Signals>

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

### <System and Network>

The terms “system” and “network” used in the present disclosure can be interchangeably used.

### <Names of Parameters and Channels>

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the numerical formulas and the like using the parameters may be different from the ones explicitly disclosed in the present disclosure. Various channels (e.g., PUCCH and PDCCH) and information elements, can be identified by any suitable names, and various names assigned to these various channels and information elements are not limitative in any respect.

### <Base Station>

The terms “Base Station (BS),” “radio base station,” “fixed station,” “NodeB,” “eNodeB (eNB),” “gNodeB (gNB),” “access point,” “transmission point,” “reception point, “transmission/reception point,” “cell,” “sector,” “cell group,” “carrier,” “component carrier,” and the like may be used interchangeably in the present disclosure. The base station may be called a macro cell, a small cell, a femtocell, or a pico cell.

The base station can accommodate one cell or a plurality of (e.g., three) cells. When the base station accommodates a plurality of cells, the entire coverage area of the base station can be divided into a plurality of smaller areas, and each of the smaller areas can provide a communication service based on a base station subsystem (e.g., small base station for indoor remote radio head (RRH)). The term “cell” or “sector” denotes part or all of the coverage area of at least one of the base station and the base station subsystem that perform the communication service in the coverage.

### <Mobile Sation>

The terms “Mobile Station (MS),” “user terminal,” “User Equipment (UE),” and “terminal” may be used interchangeably in the present disclosure.

The mobile station may be called, by those skilled in the art, a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or by some other appropriate terms.

### <Base Station/Mobile Station>

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity may be a vehicle (e.g., an automobile or an airplane), an unmanned mobile entity (e.g., a drone or an autonomous vehicle), or a robot (a manned-type or unmanned-type robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the terminal. For example, the embodiments of the present disclosure may find application in a configuration that results from replacing communication between the base station and the terminal with communication between multiple terminals (such communication may, e.g., be referred to as device-to-device (D2D), vehicle-to-everything (V2X), or the like). In this case, terminal 20 may be configured to have the functions that IAB node 10 described above has. The wordings “uplink” and “downlink” may be replaced with a corresponding wording for inter-equipment communication (e.g., “side”). For example, an uplink channel, a downlink channel, and the like may be replaced with a side channel.

Similarly, the terminal in the present disclosure may be replaced with the base station. In this case, IAB node 10 is configured to have the functions that terminal 20 described above has.

### Meaning and Interpretation of Terms

As used herein, the term “determining” may encompass a wide variety of actions. For example, “determining” may be regarded as judging, calculating, computing, processing, deriving, investigating, looking up, searching (or, search or inquiry)(e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming,” “expecting,” “considering,” and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

### <Reference Signal>

The reference signal can also be abbreviated as an RS and may also be called as a pilot depending on the applied standard.

### <Meaning of “Based On”>

The description “based on” used in the present disclosure does not mean “based only on,” unless otherwise specified. In other words, the description “based on” means both of “based only on” and “based at least on.”

### <“First” and “Second”>

Any reference to elements by using the terms “first,” “second,” and the like does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

### <“Means”>

The “means” in the configuration of each apparatus may be replaced with “section,” “circuit,” “device,” or the like.

### <Open-Ended Format>

In a case where terms “include,” “including,” and their modifications are used in the present disclosure, these terms are intended to be inclusive like the term “comprising.” Further, the term “or” used in the present disclosure is not intended to be an exclusive or.

### <Time Unit Such as TTI, Frequency Unit Such as RB, and a Radio Frame Configuration>

The radio frame may be constituted by one frame or a plurality of frames in the time domain. The one frame or each of the plurality of frames may be called a subframe in the time domain. The subframe may be further constituted by one slot or a plurality of slots in the time domain. The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (e.g., 1 to 13 symbols) that is shorter than 1 ms, or a duration that is longer than 1 ms. Note that, a unit that represents the TTI may be referred to as a slot, a mini-slot, or the like instead of a subframe.

Here, the TTI, for example, refers to a minimum time unit for scheduling in radio communication. For example, in an LTE system, the base station performs scheduling for allocating a radio resource (a frequency bandwidth, a transmit power, and the like that are used in each user terminal) on a TTI-by-TTI basis to each user terminal. Note that, the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or more TTIs (that is, one or more slots, or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that the long TTI (for example, the usual TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in the time domain, and may have a length of one slot, one mini slot, one subframe, or one TTI. One TTI and one subframe may be constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that, “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

### <Maximum Transmission Power>

The “maximum transmission power” described in the present disclosure may mean a maximum value of the transmit power, the nominal UE maximum transmit power, or the rated UE maximum transmit power.

### <Articles>

In a case where articles, such as “a,” “an,” and “the” in English, for example, are added in the present disclosure by translation, nouns following these articles may have the same meaning as used in the plural.

### <“Different”>

In the present disclosure, the expression “A and B are different” may mean that “A and B are different from each other.” Note that, the expression may also mean that “A and B are different from C.” The expressions “separated” and “coupled” may also be interpreted in the same manner as the expression “A and B are different.”

### INDUSTRIAL APPLICABILITY

An aspect of the present disclosure is useful for radio communication systems.

### REFERENCE SIGNS LIST

10, 10A, 10B, 10C IAB node
20 Terminal
101 Control section
102 CU
103 MT
104 DU

1. A radio node, comprising:
a communication section that performs a simultaneous communication operation and a single communication operation, the simultaneous communication operation being an operation in which first communication with a child node or a terminal and second communication with a parent node are simultaneously performed, the single communication operation being an operation in which either the first communication or the second communication is performed; and
a control section that determines to switch between the simultaneous communication operation and the single communication operation, based on either one of or both of a report to the parent node and indication from the parent node.

2. The radio node according to claim 1, wherein the control section determines to switch between a transmission operation and a reception operation in the simultaneous communication operation, based on either one of or both of the report and the indication.

3. The radio node according to claim 1, wherein the communication section stops communication in a guard symbol section in a resource before switching.

4. The radio node according to claim 1, wherein the communication section stops communication in a guard symbol section in a resource after switching.

5. A radio communication method, comprising:
performing a simultaneous communication operation and a single communication operation, the simultaneous communication operation being an operation in which first communication with a child node or a terminal and second communication with a parent node are simultaneously performed, the single communication operation being an operation in which either the first communication or the second communication is performed; and
determining to switch between the simultaneous communication operation and the single communication operation, based on either one of or both of a report to the parent node and indication from the parent node.

6. The radio node according to claim 2, wherein the communication section stops communication in a guard symbol section in a resource before switching.

7. The radio node according to claim 2, wherein the communication section stops communication in a guard symbol section in a resource after switching.

8. The radio node according to claim 3, wherein the communication section stops communication in a guard symbol section in a resource after switching.
